(19) United States
(12) Patent Application Publication
(10) Pub. No.: US 2014/0324338 A1
(43) Pub. Date: Oct. 30, 2014

(54) SYSTEM AND METHOD FOR CONTINUOUS AND INCREMENTAL LOCATION TRACKING OF A SMARTPHONE BASED ON SITUATION-AWARE CONTROL OF THE LEVEL OF BACKGROUND SENSING

(71) Applicant: INVIT INFORMATION SERVICES LTDA., Uberlandia (BR)

(72) Inventors: Sergio Garcia PAIM, Uberlandia (BR); Felipe Augusto Cardoso, Uberlandia (BR)

(73) Assignee: INVIT INFORMATION SERVICES LTDA., Uberlandia (BR)

(21) Appl. No.: 14/270,153

(22) Filed: May 5, 2014

Related U.S. Application Data
(63) Continuation of application No. 13/337,812, filed on Dec. 27, 2011.

(51) Int. Cl. G01C 21/12

(52) U.S. Cl. CPC G01C 21/12
USPC 701/500

(57) ABSTRACT

The invention comprises a method for controlling the level of background reading of the sensors of a smartphone in order to continuously and incrementally track its location in an energy-efficient manner based on the situations its user faces habitually.

More specifically, the present invention can be regarded as a new approach for continuous and incremental location tracking of a personal mobile device that best balances energy consumption with location accuracy during daily routine activities of a given user.

### TECHNICAL FIELD

The present invention relates to the field of pervasive computing (or so called ubiquitous computing) and deals with the problems regarding energy consumption of location tracking of a personal mobile device based on various techniques, particularly, those supported by GPS receiver hardware.

More specifically, the present invention can be regarded as a new approach for continuous and incremental location tracking of a personal mobile device that best balances energy consumption with location accuracy during daily routine activities of a given user.

### BACKGROUND OF THE INVENTION

There has been a great evolution in Mobile Computing since the advent of smartphones embedding GPS receiver hardware. The possibility to be permanently connected to the Internet and to catch user's location led to new services and applications that increase the use perspective of consumers and businesses.

Those devices, however, have originally been focused on voice telephony, as well as data applications (e.g. email, Web browsing, etc.) and convenient applications (e.g. music players, games, etc.). Thus, their grand design mainly considers foreground use, a distraction-full usability paradigm that binds the amount of computing power consumption to the amount of attention a user agrees to pay.

Conversely, using them as pervasive devices means that they must remain active (connected and processing) even if the user is not handling them. This distraction-free usability paradigm detaches the effort of a computing system from the effort of its user; this paradigm is indeed for great improvement of quality and value of those solutions but, on the other hand, it forces an already stressed limit: the battery life.

Nowadays, the background processing level is mainly managed by operating systems (OS) so those services and applications are allowed to consume only minimal resources. However, that background control is best suited for data intensive applications only (e.g. email, social networking, etc.). Regarding location tracking, the current techniques are very raw: either an application (and the Operating system—OS) is fully tracking it all the time or a background application is somehow notified by the OS on a regular basis that the position has changed.

In order to do position change broadcasts to any subscribing application, an OS uses a simple mix of many location techniques (e.g. nearness to Wi-Fi access points, GSM Triangulation, etc.) so compensating the absence of GPS Satellite signal (e.g. indoor, urban canyons, etc.), as well as trying to minimize the actual use of GPS receiver (a high energy consuming hardware).

None of them, however, has an intrinsic strategy to keep a continuous and incremental tracking of the location—a capability that a pervasive device might have. Every time an application asks the current location, the OS then starts from scratch, even if it has got the precise location seconds before. A clear indication of such basic strategy is that if a GPS signal is lost, then, the next location information an OS gives (from possibly GSM Triangulation) can be imprecise by miles even if the last GPS information is only a few seconds old. This means that a simple reasoning is not done: that the user could never run as fast as be, in a matter of seconds, miles away from the last known point.

There are many scientific papers (e.g. “A. Leonhardi, C. Nicu, and K. Rothermel. A map-based dead-reckoning protocol for updating location information. In Proceedings of 16th Int. Parallel and Distributed Processing Symposium, 2002.”) focused on the complementation of GPS location tracking with Dead Reckoning based on other sensors (i.e. accelerometer, magnetometer and gyroscope). Those are for indoor location tracking where no GPS Satellite signal is available.

Closer to the purpose of the present invention are the papers “C. You, P. Huang, H. Chu, Y. Chen, J. Chiang, S. Lau. Impact of sensor-enhanced mobility prediction on the design of energy-efficient localization” and “M. Kjærgaard, J. Langdal, T. Godsk, T. Toftkjær. EnTracked: Energy-Efficient Robust Position Tracking for Mobile Devices” which advocate the use of accelerometer as an indicator of the user's movements (of his smartphone) and, thus, using this as a governor for the level of GPS location tracking (as well as the tracking by other resources).

The present invention improves the state of art techniques by considering the user's movements as triggers for transitions among situational states. These states represent archetypal situations a user can be in, which are relevant for location tracking in a continuous, incremental and energy effective manner.

### SUMMARY OF THE INVENTION

The present invention provides a system and method for adapting the sensing level of a smartphone based on a situation-aware control. Said system comprising specific hardware for continuous monitoring the accelerometer with low energy consumption.

The term “smartphone” as herein used should not be limited to a mobile phone only. Although a smartphone is a device that combines the functions of a personal digital assistant (PDA) and a mobile phone, which currently also serves as portable media player and camera phone with high-resolution touchscreen, GPS navigation, Wi-Fi and mobile broadband access. The term smartphone as herein used may include any other portable devices with more advanced computing ability and connectivity than a contemporary phone, such as positioning resources, internet connectivity and sensors as camera, microphone and accelerometer.

The strategies available nowadays for determining the position of a smartphone are focused on either a discrete location tracking action (e.g. location-aware web search) or a continuous location tracking for foreground applications (e.g. map navigation).

None of them are well suited for a continuous background location tracking that is energy-efficient enough so that the location can be tracked accurately as it is for foreground use, but without any significant battery consumption increase that would lead the user to refuse it—considering that a user would be much more willing to get his battery consumed by a foreground application (that gives him immediate perceived value) than consumed by a background service (that eventually serves him contextually and proactively).

Hence, the present invention is indeed a way to overcome a critical obstacle for the transformation of an ordinary smartphone into an effective pervasive device, allowing a great new set of pervasive/ubiquitous scenarios—the more often and precise are the contextual reports that a continuous web service receives, the more proactive and valuable this web service can be.

The present invention considers an archetypal daily routine of a given user in order to intelligently select which sensor of a smartphone is best for continuously keeping the location updated. And it does so considering that average user must walk in order to move from one place to another, as well as to get into or out of a vehicle (e.g. a car, a bus, a train, a motorcycle, etc.). It continuously controls the type of movement the smartphone is doing (read from the accelerometer) and then adjusts the activation of other sensors accordingly.

Doing so, the present invention uses a cheap continuous calculation of the movement of a smartphone in order to use an expensive radio-based location tracking only when likely needed. This leads to a great improvement of accuracy of location tracking by the cost of a small energy consumption increase, making possible a permanent location tracking effective enough for most of the daily situations a user faces.

### Technical/Functional Advantages

Continuous and incremental location tracking: the present invention allows the keeping of location records so a new sample of the location is only needed when the estimated present level of accuracy is worse than a given threshold. Additionally, the new sample is compared to the recent records, thus eliminating likely erroneous readings or compensating imprecise ones;

Energy savings: the present invention prevents redundant sensor reading (especially from GPS receiver), when it is likely that the smartphone has not moved significantly since last location sample. Considering that the sum of small movements can still be under a given location accuracy threshold, a correction by a new sample from sensors can be avoided in many common situations where a user is handling or carrying a smartphone but not changing substantially its (his) location (i.e. making a call, surfing the Web, using an application, holding it, keeping it on pocket, etc.);

Contextual activation of Dead Reckoning calculations: the use of many techniques for location tracking based on Dead Reckoning is prevented due to the difficulty of determining where and whether to start calculating it. Thanks to said continuous location tracking capability and said situational control of accuracy, the present invention better knows when to start complementing conventional location tracking resources by Dead Reckoning and where the reference starting point for it is.

### BRIEF DESCRIPTION OF THE DRAWINGS

The present invention may be better understood by the following detailed description in conjunction with the accompanying drawings, wherein like reference underscored numerals designate like structural and/or behavioral elements of the present invention, and in which:

FIG. 1 depicts an archetypal scenario of a daily routine of a person, and the many different situations that generally affect the process of continuous location tracking.

FIG. 2 depicts the daily situations of a person and the transitions among them in order to control the background sensing level for location tracking.

FIG. 3 depicts a cost-effective method for determining if the user has started or stopped walking.

FIG. 4 depicts the states the present invention considers so as to vary the level of accelerometer sensing.

FIG. 5 depicts a situation-aware method for continuous and incremental location tracking.

### DESCRIPTION OF THE PREFERABLE EMBODIMENTS OF THE INVENTION

The following numerous specific description details are set forth in order to provide for those skilled in the art a thoroughly understanding of the present invention.

Some terminology is used to describe certain features of one or more embodiments of the present invention.

The term “location” is used to identify a point or an area of interest on or near the Earth's surface. The term “Dead Reckoning” is used to refer to the process of calculating the current location of a person by using a previously determined location. The term “variance”, from statistics, is a measure of how far a set of numbers are spread out from each other.

Accordingly, the present invention provides techniques, a system, methods and functionalities for continuous and incremental location tracking of a personal mobile device—with balance of energy consumption versus location accuracy—based on daily routine activities of a given user.

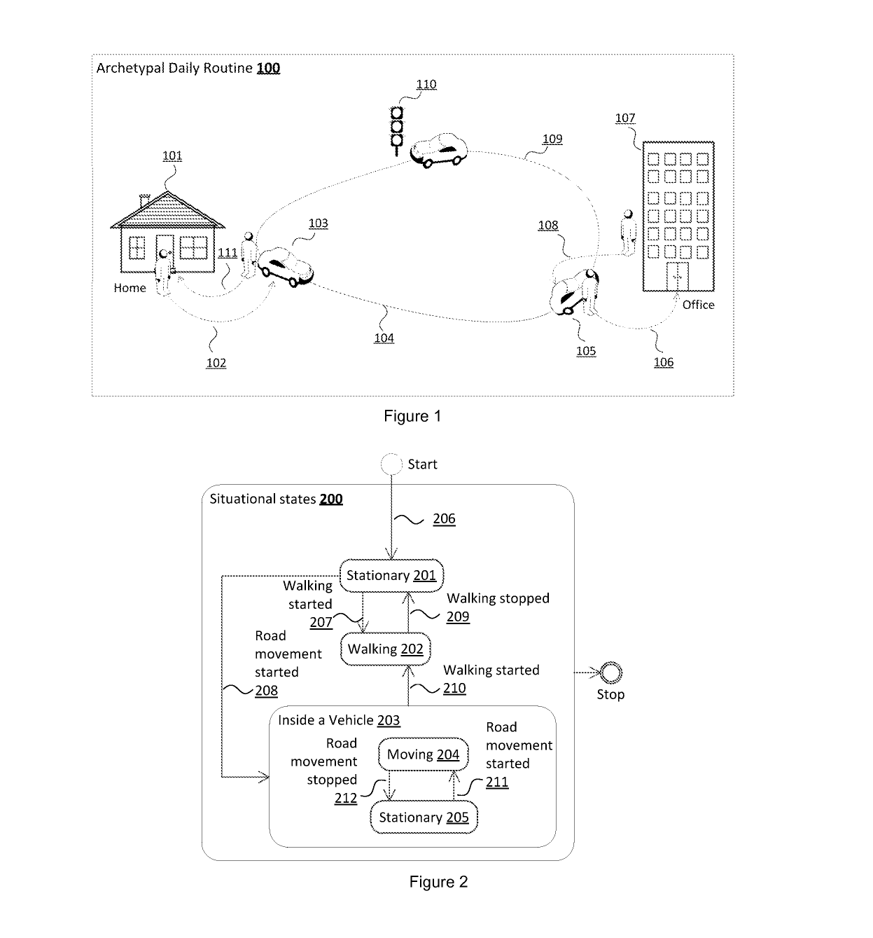

Embodiments of the main aspects of the present invention can be appreciated by the discussion below with reference to FIG. 1 and then to the remaining figures. However, those skilled in the art will promptly appreciate that the detailed description given herein with respect to these figures is for explanatory purposes only, as the present invention extends beyond these limited embodiments.

FIG. 1 is a schematic scope of the daily routine 100 of a given person that uses some road vehicle to go to office. The purpose of this schema is to illustrate the different related situations that affect the process of continuous location tracking.

The analysis starts when that person is at home 101. The place “home” has been chosen so as to illustrate a common place he stays for a considerable period of time before leaving it to go to another place, staying for another significant period of time. This common routine considers that the person uses a vehicle to move to greater distances, and these situations represent a typical situation for continuous location tracking.

In situations like this no location updates are needed until the person leaves the place (home), and he does so walking up 102 to the vehicle. The fact that the user has started walking likely determines that he has left home. Meanwhile, his walking location updates are now needed to keep tracking of him (meaning the contextual need for activation of Dead Reckoning calculation). Kindly note that walking, in this context, also comprehends running, that is, it means the movement on foot from one place to another.

Arriving at the vehicle, he stops walking and enters it 103. Inside it he starts his route up to office 104. Obviously, during all the time he is inside the vehicle, he does not walk. During the route, location updates are also needed.

Actually, they are most needed because the speed and range of the movement of a vehicle are likely greater than the ones of a walk. This is the case where a standard, continuous location tracking based on GPS receiver (by a given update rate) is justified the most.

When he arrives at office 105, he leaves the vehicle and starts walking 106 until he comes into the office 107. The fact that the user has started walking determines that he has left the vehicle 105. In this situation, location updates can be done once again by Dead Reckoning, having the GPS receiver as a means for correction whenever the estimated location accuracy is not good enough.

At the office 107, he stops walking. Note that the fact the user has stopped walking can determine two different situations: that he has entered a vehicle 103, as shown above, or that he is stationary at some place—in both cases, there is no need to continuously update his location because he is stationary. In the first case, Dead Reckoning will be applied whenever he starts walking (e.g. inside the office), with corrections by GPS receiver as above stated. In the second case, the present invention starts a standard, continuous location tracking (by GPS receiver) every time it identifies that the vehicle is moving (as below stated).

In the present schematic scope, when the user is leaving office 107, he walks back 108 to the vehicle 105. In terms of location tracking, the office-home route 109 is equivalent to the home-office route 104. Even when the vehicle needs to stop 110 (e.g. due to a traffic light or traffic congestion), the continuous location tracking process is aware that the user is inside the vehicle (i.e. he has not walked out). This situation will change only when he leaves the vehicle and starts walking 111 to enter home 101.

Summing up, the archetypal daily routine shows that most of the time the location of the average user (his smartphone) can be accurately kept up-to-date with minimal radio location tracking (especially by GPS) based on the actual movement patterns presented above.

FIG. 2 depicts the situational states 200 in which a person may be in during his daily activities, as well as the transitions among those states relevant for best controlling the need of background sensing for continuous location tracking. As shown in FIG. 1, the central innovative aspect of the present invention is the realization that practically all daily situations that a person faces can, for the purpose of controlling the level of background sensing, be categorized in the following states: Stationary 201, Walking 202, and Inside a Vehicle 203 (subdivided in: Moving 204 and Stationary 205).

The Stationary 201 state is characterized by the fact that once its location is determined, no new location samples are required (as schematized above, in FIG. 1, when the person is at home or at office). In these cases, when the smartphone is resting relatively to Earth (e.g. on the table), a new location sample is not necessary because until an interaction over the device happens to change its resting situation, its location remains the same. Even when the person is handling the device (e.g. making a phone call), small movements can be ignored when the sum of them generates only minor displacements (still under a given location accuracy threshold).

By the fact that walking is the main form of a person to locomote, the Walking 202 state is characterized by the presence of footsteps (as schematized above, in FIG. 1, when the person arrives or leaves home or the office, as well as walks inside those places) and can be used as the main indication of user's intention to move, that is, the main indication that his location is changing. In this state, a new location is required only when the movement generated by steps changes the estimated location accuracy to worse than a given threshold.

Please note that the actual Dead Reckoning technique used by the present invention is not under the scope of this invention (only the contextual activation of it as above and below stated). Hence, the present invention considers the application of prior art Dead Reckoning so as to improve said location accuracy during movements generated by footsteps (walk or run). Dead Reckoning can be used for continuous location tracking, mainly in situations where GPS signal is not available (e.g. indoor areas).

By the fact that a vehicle is a device that is used to transport people, the state “Inside of a Vehicle” 203 is used to represent the movement of the person carried by it (when it is moving 204) without the need of his walking (as schematized above, in FIG. 1, during home-office and office-home routes). Considering that the movements of a smartphone inside a moving vehicle still comprise minor movements (with no relevant use for Dead Reckoning) a new location by GPS receiver is required on a regular basis (by a given update rate) so as to continuously location track it, as above stated.

On the other hand, the same characteristics of the location sampling of the Stationary state 201 can be applied to the Stationary sub-state 205 of the state “Inside of a Vehicle” 203.

The present invention starts itself 206 in the Stationary state 201. Every time it detects (as below stated) that the person carrying the smartphone has started walking 207, it changes to Walking state 202. If the person has stopped walking 209, then the present invention changes to Stationary state 201.

When in Stationary state 201, the present invention also continuously verifies if the user is in a road movement (as stated below), that is, if he is inside a moving vehicle. If this is the case 208, then the present invention changes to Moving sub-state 204 of the state “Inside a Vehicle” 203. If the present invention detects that the road movement has stopped 212, then it changes to Stationary sub-state 205. Accordingly, it changes back to Moving sub-state 204, if the road movement has resumed 211. The present invention only leaves the state “Inside a Vehicle” 203 if it has detected that the person had started walking 210 (meaning that he walked out of the vehicle).

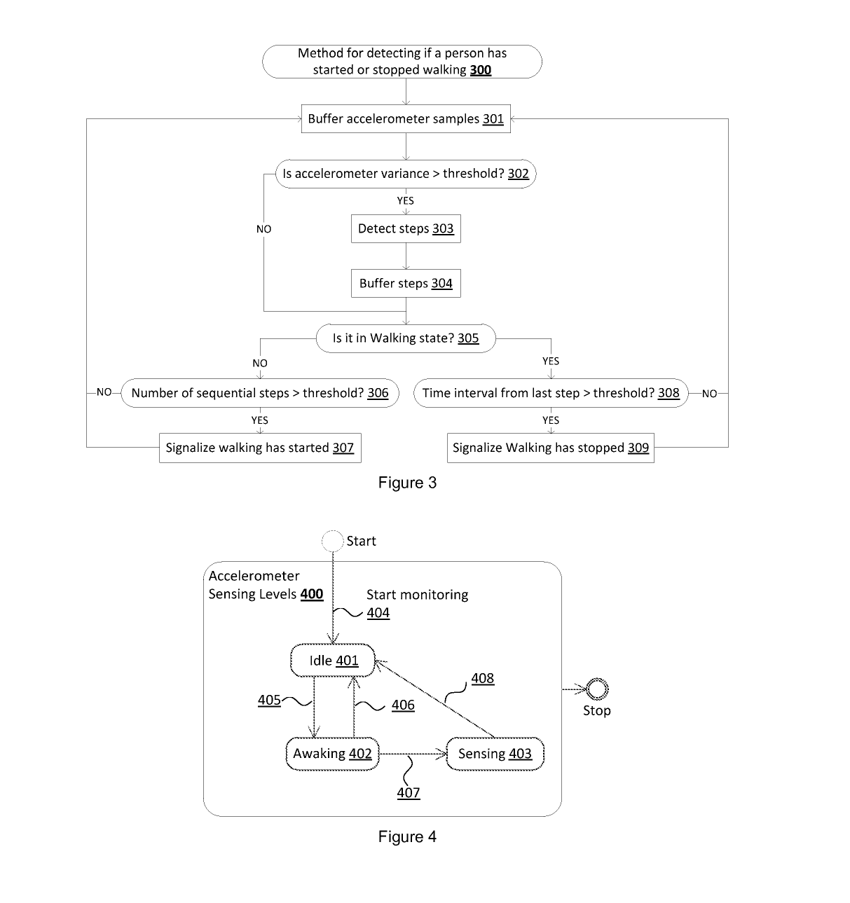

FIG. 3 gives the overall flowchart of the method that analyzes the acceleration data to determine if the user has started or stopped walking 300. The acceleration is measured by the accelerometer sensor present in smartphones. More specifically, the present method detects footsteps of a person (when carrying the smartphone), and analyzes their sequence to signalize itself, if the user has started or stopped walking. The present invention uses a technique that detects steps regardless the smartphone carrying location (e.g. hand holding, in any pocket, using the phone, inside any portable bag, etc.). The present technique of steps detecting is standard and is not included in the present patent application—only its use together with the context-aware control of background sensing for that matter, comprehended by said method 300, is considered.

The present method requires full-time accelerometer monitoring. This obligation asks for the accelerometer sampling rate to be balanced, allowing the detection of steps with the lowest possible power consumption (i.e. sampling rate could be as low as 5 Hz). This sampling process produces a buffer of acceleration data values 301 that sequentially stores them in memory. Each sample contains the values of acceleration in three axes (X, Y, Z) and their respective timestamp (the time at which the sampling event happened).

When the smartphone is resting relatively to Earth, only the gravity acceleration is measured due to Einstein's equivalence principle. When the smartphone is carried by a person during a walk, both gravity acceleration and stepping movement acceleration are captured by the accelerometer. Walking steps profiles are distinguished by a region of high variance in the measured acceleration data stream.

So, after waiting for a given number of samples to be buffered 301 (e.g. equivalent to 30 seconds) at a said given lowest possible sampling rate, that number of samples is split in a given number of frames (e.g. 3). The variance of samples is then calculated for each frame. Each of those calculated variances is tested to check if it is greater than a given threshold 302 (e.g. σ²>1). If there is at least one frame of variance greater than said threshold, those buffered samples are marked as suspects of having footsteps. This pre-analysis serves as a means of preventing unnecessary deeper calculation for steps detection 303.

After the decision on doing steps detection, the present invention applies standard techniques to that matter and buffers all footsteps detected in a buffer of steps 304.

If the present invention is not in said Walking state 305, the buffer of steps will be analyzed to determine if the person has started walking. At this stage, the steps are counted in order to find at least a given amount of sequential steps 306 (e.g. 5 steps), meaning that the person has started walking 307. Steps are considered sequential when they happen between time intervals shorter than a given threshold (e.g. 1 second).

If the present invention is already in said Walking state 305, steps will be analyzed to determine whether the person has stopped walking. To do so, the step buffer is analyzed so as to find the time interval from the last step detected. Then, if the detected interval is longer than a given threshold (e.g. 10 seconds) 308, it is considered that the person has stopped walking 309.

FIG. 4 depicts the states that the present invention considers so as to vary the level of background accelerometer sensing 400.

In a continuous monitoring of accelerometer, one of the most important things is the battery consumption (despite the fact that the accelerometer hardware has low power consumption). The consumption of this process is directly proportional to the accelerometer sample rate because the greater the number of samples to be processed, the greater the consumption of main processor time (a high power consuming resource). On the other hand, the lower the number of samples, the lower the accuracy of the analysis.

Another important aspect of present invention is the definition of states Idle 401, Awaking 402 and Sensing 403 as a means for efficiently monitoring the accelerometer so as to identify whether the person (his smartphone) is walking (steps counting and Dead Reckoning) or inside a moving vehicle.

Whenever the present invention is in said Stationary state or said Stationary sub-state, the acceleration monitoring is initialized 404 and the Idle state 401 (a low-sensing level) is set. When in such state, the present invention uses this minimal monitoring to identify indications that a relevant movement is happening (e.g. a walk, a run, a vehicle ride, a smartphone handling for a phone call, etc.).

If that is the case 405, the present invention changes to Awaking state 402 (a mid-sensing level), and then tries to identify specific movement patterns that indicate a displacement of the person (e.g. a walk, a vehicle ride).

If no displacement is identified 406, the present invention changes back to Idle state 401. Otherwise 407, it changes to Sensing state 403 (a high-sensing level) until displacements are no more captured 408, therefore it changes back to Idle state 401.

Please note that only when the present invention is in Sensing state 403 that other sensors needed by Dead Reckoning calculations (e.g. magnetometer, gyroscope, etc.) are activated and analyzed, which greatly saves battery life.

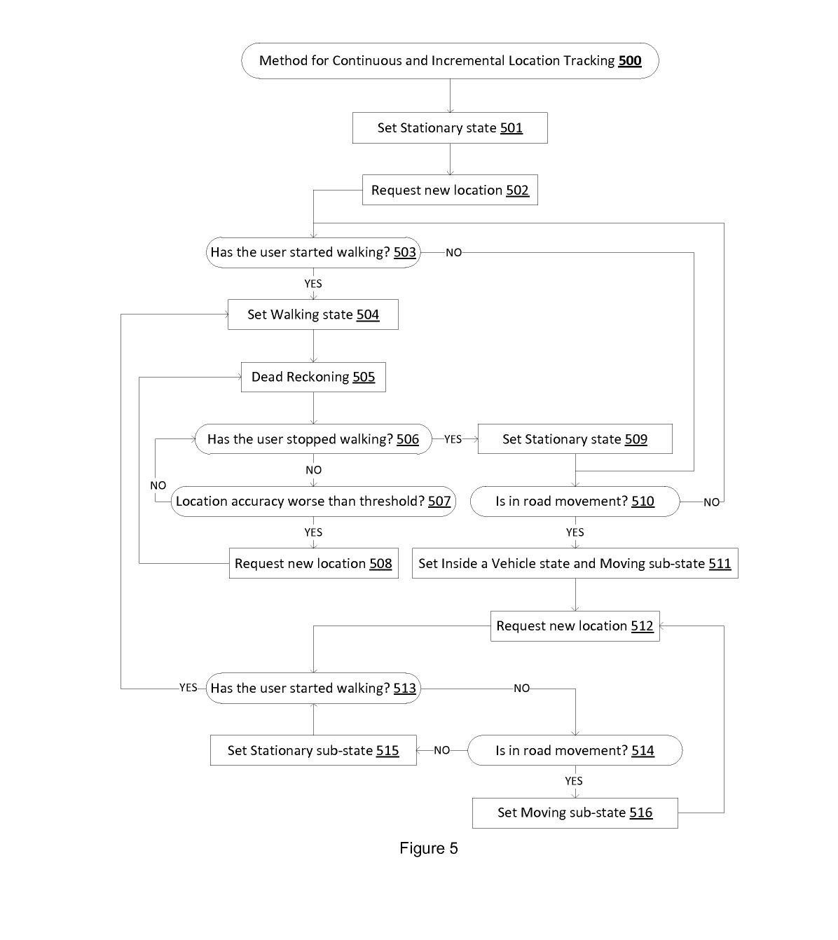

FIG. 5 gives the overall flowchart of the method for continuous and incremental location tracking 500 based on the states and methods shown in FIGS. 2, 3 and 4, and also described in the embodiments of the present invention.

When the present invention starts, it enters said Stationary state 501 and requests a new location sample (by GPS receiver) 502 so as to firstly determine the location of the smartphone. As above stated, one important aspect of the present invention is that, until the movements are significantly enough to decrease the last location accuracy (i.e. a continuous walking), a new location sample is not necessary. So, the present method awaits in the current state (said Stationary) until it has been signalized that the user has started walking 503 or that he is in a moving vehicle 510.

So, when the signal that the user started walking is received (as above stated), the state of the location tracking is changed to said Walking state 504 and then the present invention contextually starts a Dead Reckoning calculation 505 having the last location sample 502 as its starting point. It keeps Dead Reckoning calculation active until it has been signalized that the user has stopped walking 506. During that, it also regularly checks if the estimated location accuracy is worse than a given threshold (e.g. 300 feet) 507, requesting, if positive, a new location sample (by GPS receiver) 508 for correcting it (fixing the accumulated error of Dead Reckoning).

The location sampling 508 can also be checked back against the location estimated by its parallel Dead Reckoning calculation. If the new location sample has accuracy lower than the estimated one, then the present invention ignores it. This remediates the said OS managed location tracking that gives an imprecise location (due to lack of GPS signal) only seconds after having got a precise one.

If the user has stopped walking 506, then the present invention changes to said Stationary state 509 and checks whether he is in a moving vehicle 510. It does so using standard accelerometer analysis (according to said Idle, Awaking and Sensing states) that checks if there are any continuous acceleration occurrences generated by a turning, speeding-up or braking vehicle. If that is the case then it changes to said Moving sub-state of state “Inside a Vehicle” 511. Otherwise, it stays in said Stationary state until the user has started walking again 503.

The present invention stays in said state “Inside a Vehicle” and requests a new location sample (by GPS Receiver) 512 as above stated. It remains in said state until it is signalized, as above stated, that the user has started walking 513, then changing to said Walking state 504.

It also starts to control whether the vehicle is in movement or not 514, changing to the correspondent sub-states, Stationary 515 or Moving 516. When in said Moving sub-state, it requests a new location sample (by GPS Receiver) 512 on a given update rate (e.g. every 5 minutes).

The methods and states herein described represent altogether an outstanding way of overcoming the obstacles preventing the use of a contemporary smartphone as a pervasive device that is all the time keeping track of its user. Thanks to that, a great new set of automation scenarios can be implemented toward the powerful concept of ubiquitous computing.

Many features and advantages of the present invention are apparent from the written description, and, thus, it is intended by the appended claims to cover all such features and advantages of the present invention.

Although the concepts disclosed herein have been described in connection with the preferred form of practicing them and modifications thereto, those of ordinary skill in the art will understand that many other modifications can be made thereto within the scope of the claims that follow. Accordingly, it is not intended that the scope of these concepts in any way be limited by the above description, but instead be determined entirely by reference to the claims that follow.

1. A method for continuously and incrementally tracking the location of a smartphone, said method comprising:
entering said Stationary state for the location tracking background process running in the smartphone;
requesting the OS a location sample of the smartphone;
initiating walking start detection using the sensors of the smartphone;
keeping in said Stationary state, if negative, and, thus, continuously monitoring the accelerometer of said smartphone for said walking start detection;
entering said Walking state, if positive, thus contextually starting said Dead Reckoning calculation having last known location as starting point;
continuously doing said Dead Reckoning calculation, whenever in said Walking state;
requesting the operating system of the smartphone a new location sample, whenever in said Walking state and said location accuracy estimated by said Dead Reckoning calculation is worse than said given accuracy threshold;
ignoring said new location sample from the operating system of the smartphone if its accuracy is worse then said estimated location accuracy;
entering said Stationary state whenever said walking stop detection is true;
continuously accelerometer monitoring, whenever in said Stationary state, for said walking start detection, thus, if positive, entering said Walking state;
continuously monitoring accelerometer of the smartphone, whenever in said Stationary state, for said road movement detection, thus, if positive, entering said Moving sub-state of said state “Inside a Vehicle”;
regularly requesting the operating system a new location sample in said given update rate whenever in said Moving sub-state;
continuously monitoring the accelerometer of the smartphone, whenever in said state “Inside a Vehicle”, for said walking start detection, thus, if positive, entering said Walking state; and
continuously monitoring the accelerometer of the smartphone, whenever in said state “Inside a Vehicle”, for said road movement detection, thus, if positive, entering said Moving sub-state or, if negative, entering said Stationary sub-state of said state “Inside a Vehicle”.

2. A method, as in claim 1, further comprising gradually varying the accelerometer sensing level, while in said Stationary state or said Stationary sub-state, said method comprising:
initiating in said Idle state, thus sampling the accelerometer of the smartphone in said given low-rate sampling;
entering said Awaking state whenever said relevant movement has been detected, thus sampling the accelerometer of said smartphone in said given mid-rate sampling and performing walk start detection and road movements detection;
entering said Sensing state, if said walking start detection is true or said road movements have been identified;
sampling the accelerometer of the smartphone in said given high-rate sampling, as well as activating other sensors for Dead Reckoning accordingly, whenever in said Sensing state; and
returning to said Idle state whenever said walking stop detection is true or no said road movements have been identified.

3. A method, as in claim 1, further comprising walking detection, said method comprising:
buffering a said given number of accelerometer samples;
splitting them into a given number of frames;
applying statistical analysis using a smartphone in which the process runs in background, so as to verify the probability of step occurrence within frames by checking if the variance of acceleration samples is greater than said given variance threshold;
marking said frames as footstep suspects, if positive, thus sending them for said conventional footstep detection; and
signalizing said walking start and walking stop detections accordingly.

4. A method, as in claim 1, wherein said walking start detection is done by identifying that said given number of footsteps has occurred and that there has been no time interval between each two sequential ones longer than said given threshold of time.

5. A method, as in claim 1, wherein said walking stop detection is done by identifying if no steps have been detected for more than said given period of time.

6. A method as in claim 1, wherein said road movement detection is done by identifying said continuous acceleration patterns indicating that the smartphone is inside a turning, speeding-up or braking vehicle.

7. System for continuously and incrementally tracking the location of a smartphone, said system comprising means for implementing the method of claims 1-6.

8. System as in claim 7, comprising specific hardware for continuous monitoring the accelerometer with low energy consumption.

9. A method, as in claim 1, wherein said Stationary state is entered when a person is at home.
